(19) United States
(12) Patent Application Publication
(10) Pub. No.: US 2025/0025869 A1
(43) Pub. Date: Jan. 23, 2025

(54) MATERIAL FOR REMOVING IMPURITIES IN ORGANIC SOLVENT AND METHOD FOR REMOVING IMPURITIES IN ORGANIC SOLVENT

(71) Applicant: KURITA WATER INDUSTRIES LTD., Tokyo (JP)

(72) Inventors: Takahiro KAWAKATSU, Tokyo (JP); Yu FUJIMURA, Tokyo (JP); Takaaki CHUUMAN, Tokyo (JP)

(73) Assignee: KURITA WATER INDUSTRIES LTD., Tokyo (JP)

(21) Appl. No.: 18/713,695

(22) PCT Filed: Sep. 14, 2022
(86) PCT No.: PCT/JP2022/034392

§ 371 Date: May 27, 2024

(30) Foreign Application Priority Data
Dec. 1, 2021 (JP) 2021-195467

(51) Int. Cl. B01J 41/14; B01J 39/07; B01J 41/07; B01J 47/014

(52) U.S. Cl. CPC B01J 41/14; B01J 39/07; B01J 41/07; B01J 47/014

(57) ABSTRACT

Provided is a material for removing impurities in an organic solvent having a water content of 1,000 ppm or less, the material comprising a porous ion exchange resin. It is preferred that the porous ion exchange resin has, as an ion exchange group, at least one functional group selected from the group consisting of a primary amino group, a secondary amino group, a tertiary amino group and a quaternary ammonium group. Also provided is a method for removing impurities in an organic solvent, the method comprising bringing the material for removing impurities in an organic solvent into contact with an organic solvent having a water content of 1,000 ppm or less.

### TECHNICAL FIELD

The present invention relates to a material for removing impurities in an organic solvent that removes impurities in organic solvents used in the manufacturing and cleaning processes of mechanical parts and electronic parts, or for chemical synthesis, and also relates to a method for removing impurities in an organic solvent.

### DESCRIPTION OF RELATED ART

An ultrapure water production and supply system used in a semiconductor manufacturing process etc. is equipped with a cross-flow type ultrafiltration membrane (UF membrane) device for removing particulates at the end of the subsystem, and removes nanometer-sized particles by operating at a water recovery rate of 90-99%. In addition, it is also being considered to install a mini subsystem as a point-of-use polisher just before the cleaning machine for cleaning semiconductors and electronic materials, to install a UF membrane device for removing particulates at the final stage, or to install a UF membrane for removing particulates just before the nozzle in the cleaning machine at the point of use to highly remove smaller sized particulates.

In recent years, with the development of semiconductor manufacturing processes, the management of particulates in water has become increasingly strict, for example, in the International Technology Roadmap for Semiconductors (ITRS), in 2019, the guaranteed value for particle size >11.9 nm is required to be <1000 particles/L.

On the other hand, regarding the removal of particulates in organic solvents, no clear particulate management has been established as in the case of the ultrapure water mentioned above. However, with the miniaturization of semiconductor structures, in order to prevent pattern collapse, organic solvents with low surface tension have come to be used for wafer cleaning, and as a result, the need to remove particulates and the like in organic solvents has increased.

Conventionally, in an ultrapure water production device, the following proposals have been made as techniques for highly removing impurities such as particulates in water to increase purity.

Patent Literature 1 describes that a membrane separation means is provided in any of a pretreatment device, a primary pure water device, a secondary pure water device (subsystem), or a recovery device that constitute an ultrapure water supply device, and a reverse osmosis membrane treated to reduce amine elution is disposed at the subsequent stage. Although particulates may be removed using a reverse osmosis membrane, it is not preferable to provide a reverse osmosis membrane for the following reasons. That is, the pressure has to be increased to operate the reverse osmosis membrane, and the amount of permeated water is as small as about 1 m³/m²/day at a pressure of 0.75 MPa. However, in the current system that uses a UF membrane, the amount of water is 7 m³/m²/day, which is more than 50 times as much, at a pressure of 0.1 MPa, and the reverse osmosis membranes requires an enormous membrane area to cover the same amount of water as a UF membrane. Furthermore, driving a boost pump poses a risk of generating new particles and metals.

Patent Literature 2 describes that a functional material having an anionic functional group or a reverse osmosis membrane is disposed after the UF membrane in the ultrapure water line, but the purpose of the functional material having an anionic functional group or the reverse osmosis membrane is to reduce amines, and it is not suitable for removing particulates with a particle size of 10 nm or less, which are targeted for removal in the present invention. Further, it is not preferable to dispose a reverse osmosis membrane as in Patent Literature 1 mentioned above.

Patent Literature 3 also describes that a reverse osmosis membrane device is provided before the final stage UF membrane device in the subsystem, but there is a problem similar to that of Patent Literature 1 mentioned above.

Patent Literature 4 describes that a pre-filter is built into a membrane module used in an ultrapure water production line to remove particles, but there is a problem that the smaller the particle size to be separated, the lower the water permeability.

Patent Literature 5 describes that after being filtered with a UF membrane filtration device having a filtration membrane that is not modified with an ion exchange group, the treated water of an electrodeionization device is then treated with a membrane filtration device having a MF membrane modified with an ion exchange group, but as the ion exchange group, merely a cation exchange group such as a sulfonic acid group and an iminodiacetic acid group are exemplified. The definition of the ion exchange group also includes an anion exchange group, but there is no description of types or targets for removal thereof.

Patent Literature 6 describes that an anion adsorption membrane device is disposed after the UF membrane device in the subsystem, and reports experimental results using silica as the removal target, but there is no description regarding the type of the anion exchange group or the size of the particulates. It is generally known that a strong anion exchange group is required when removing ionic silica (Diaion 1 Ion Exchange Resin/Synthetic Adsorbent Manual, Mitsubishi Chemical Corporation, p15), so it is believed that Patent Literature 5 also uses a membrane having a strong anion exchange group.

Patent Literature 7 describes that a polyketone porous membrane contains one or more functional groups selected from a group consisting of a primary amino group, a secondary amino group, a tertiary amino group, and a quaternary ammonium salt, and has an anion exchange capacity of 0.01 to 10 meq/g, and the polyketone porous membrane can efficiently remove impurities such as particulates, gels, and viruses in manufacturing processes for semiconductor/electronic component manufacturing, biopharmaceuticals, chemicals, and food industries. There are also descriptions suggesting that 10 nm particulates and anion particles smaller than the pore size of the porous membrane may be removed.

However, Patent Literature 7 does not describe the application of the polyketone porous membrane to an ultrapure water production process.

Patent Literature 8 describes the application of such a polyketone porous membrane to an ultrapure water production process, but there is no mention of removal of impurities such as particulates, metals, and ions in organic solvents.

As mentioned above, proposals have been made to remove impurities in water in ultrapure water production systems used for manufacturing or cleaning electronic parts, etc., but no proposals have been made regarding materials or devices that can remove impurities (particulates, metals, and ions) in organic solvents to the level required for ultrapure water in such applications.

In addition, in applications other than the manufacturing and cleaning of electronic parts, for example, in the manufacturing and cleaning process of mechanical parts, or in chemical synthesis, in order to improve product yield and eliminate the influence of impurities, there is a need to highly remove impurities, especially particulates, contained in an organic solvent.

### RELATED ART

### Patent Literature

Patent Literature 1: Japanese Patent No. 3906684
Patent Literature 2: Japanese Patent No. 4508469
Patent Literature 3: Japanese Patent Application Laid-Open No. 5-138167
Patent Literature 4: Japanese Patent No. 3059238
Patent Literature 5: Japanese Patent Application Laid-Open No. 2004-283710
Patent Literature 6: Japanese Patent Application Laid-Open No. 10-216721
Patent Literature 7: Japanese Patent Application Laid-Open No. 2014-173013
Patent Literature 8: Japanese Patent Application Laid-Open No. 2016-155052

### SUMMARY

### Technical Problem

In view of the above-mentioned prior art, an object of the present invention is to provide a material for removing impurities in an organic solvent and a method for removing impurities in an organic solvent that can highly remove impurities in organic solvents used for manufacturing and cleaning processes of mechanical parts and electronic parts, or for chemical synthesis.

### Solution to the Problem

The present inventors have discovered that porous ion exchange resin exhibits high impurity removal performance for an organic solvent with a water content of 1,000 ppm or less.

That is, the present inventors conducted the following studies in the process of arriving at the present invention.

Conventional methods for removing impurities in water have been based on adsorption and removal using ion exchange groups that have an opposite charge to the impurities. Therefore, the present inventors carried out removal using oppositely charged groups using the same idea for organic solvents, but the impurity removal rate was low. For this reason, various studies were conducted on polymeric materials that serve as base materials, and it was found that the impurity removal capability of porous ion exchange resin is superior to gel type ion exchange resin. Even when using the porous ion exchange resin, satisfactory results were not necessarily obtained; however, it has been found that by reducing the water content of the organic solvent to 1,000 ppm or less, the impurity removal rate, which was previously 20% or less, can be improved to 40% or more.

The present invention has been achieved based on such knowledge, and the gist thereof is as follows.

[1] A material for removing impurities in an organic solvent has a water content of 1,000 ppm or less, and the material includes porous ion exchange resin.

[2] In the material for removing impurities in the organic solvent according to [1], the porous ion exchange resin has one or more functional groups selected from a group consisting of a primary amino group, a secondary amino group, a tertiary amino group, and a quaternary ammonium group as an ion exchange group.

[3] In the material for removing impurities in the organic solvent according to [1] or [2], the porous ion exchange resin has a specific surface area of 1 m²/g or more.

[4] In the material for removing impurities in the organic solvent according to any one of [1] to [3], the impurities are silica particulates having a particle size of 30 nm or less.

[5] A method for removing impurities in an organic solvent includes bringing the material for removing impurities in the organic solvent according to any one of [1] to [4] into contact with an organic solvent having a water content of 1,000 ppm or less.

[6] A method for removing impurities in an organic solvent includes a dehydration process of dehydrating an organic solvent with a water content of more than 1,000 ppm to a water content of 1,000 ppm or less, and an impurity removing process of bringing the organic solvent dehydrated into contact with the material for removing impurities in the organic solvent according to any one of [1] to [4].

### Effects

According to the present invention, impurities such as particulates, metals, and ions can be highly and efficiently removed in organic solvents used for manufacturing and cleaning processes of mechanical parts and electronic parts, or for chemical synthesis.

### DESCRIPTION OF EMBODIMENTS

The present invention will be described in detail below.

A material for removing impurities in an organic solvent of the present invention includes porous ion exchange resin.

The porous ion exchange resin has a large specific surface area and is excellent in removing impurities in an organic solvent.

An ion exchange group of the porous ion exchange resin includes a primary amino group, a secondary amino group, a tertiary amino group, a quaternary ammonium group, a carboxyl group, a sulfonic acid group, a phosphoric acid group, a phosphonic acid group, a phosphinic acid group, a hydroxyl group, a phenol group, a pyridine group, an amide group, etc., but is not limited thereto. These functional groups may be not only H type or OH type but also salt type such as Cl or Na. In the present invention, ion exchange resin into which at least one type of the functional groups has been introduced may be used, and mixed ion exchange resin having different ion exchange groups may be obtained by using multiple types of ion exchange resin each having a different ion exchange group introduced therein.

Among the ion exchange groups, from the viewpoint of impurity removal capability, a primary amino group, a secondary amino group, a tertiary amino group, and a quaternary ammonium group are preferred, and a quaternary ammonium group is particularly preferred.

The specific surface area of the porous ion exchange resin is preferably large from the viewpoint of impurity removal capability, and the specific surface area measured by mercury porosimetry is preferably 1 m²/g or more, and particularly 7 m²/g or more. Note that the specific surface area of the porous ion exchange resin is usually 30 m²/g or less from the viewpoint of maintaining strength.

Examples of the types of ion exchange resin include polystyrene-based ion exchange resin having a skeleton of poly(styrene-divinylbenzene), poly(styrene-ethylstyrene-divinylbenzene), poly((meth)acrylic acid-divinylbenzene), polydivinylbenzene, etc.; acrylic ion exchange resin having a skeleton of poly(2,3-dihydroxypropyl methacrylate-ethylene dimethacrylate), poly(hydroxyethyl methacrylate-trimethylolpropane trimethacrylate), poly(meth)acrylic ester, etc., acrylic ion exchange resin having a skeleton of polyacrylic acid ester, etc., and acrylic ion exchange resin having a skeleton of polyacrylamide etc.; polyvinyl alcohol-based ion exchange resin having a skeleton of poly(vinyl alcohol-trialyl isocyanurate), etc.; and polyvinyl ether-based ion exchange resin having a skeleton of poly(2-hydroxyethyl vinyl ether-diethylene glycol vinyl ether), poly(chloroethyl vinyl ether-triethylene glycol vinyl ether), etc.

Among the ion exchange resin, polystyrene-based ion exchange resin and acrylic-based ion exchange resin are preferred, and polystyrene-base ion exchange resin is particularly preferred since the aforementioned are often used industrially.

The impurities in the organic solvent that are removed by the material for removing impurities of the present invention include various inorganic particulates, organic particulates, metal particulates, ions, gels, viruses, etc., but the present invention is particularly effective for removing particulates with a particle size of 30 nm or less, especially silica particulates. Note that the impurity concentration in the organic solvent is not particularly restricted, but is usually about 1 to 1,000 ppm.

To bring the material for removing impurities into contact with an organic solvent, the material for removing impurities is put into a container containing the organic solvent, in addition to a method of immersion, a method of passing an organic solvent through a column containing the material for removing impurities may be used, but is not limited thereto.

The organic solvent to be treated in the present invention is not particularly limited, but exemplary examples include the following.

Alcohols such as methanol, ethanol, isopropyl alcohol; halogenated hydrocarbons such as methylene chloride, chloroform, carbon tetrachloride, trichlorethylene, perchlorethylene, 1,1,1-trichloroethane, Freon 113, chlorobenzene, o-, m-, p-dichlorobenzene, o-, m-, p-dichlorobenzene, o-, m-, p-chlorotoluene; ethers such as ethyl ether; Epoxies such as PO and BO; hydrocarbons such as hexane, cyclohexane, benzene, toluene, and xylene; Ketones such as acetone, MEK, and MIBK; esters such as ethyl acetate, n-propyl, iso-propyl, n-butyl, sec-butyl, tert-butyl; n-methyl-2-pyrrolidone (NMP); and a mixed solvent of two or more of the above organic solvents.

The present invention is particularly suitable for treating organic solvents used in semiconductor manufacturing processes, such as isopropyl alcohol (IPA) and N-methyl-2-pyrrolidone (NMP).

The present invention is characterized in that such an organic solvent is brought into contact with the material for removing impurities at a water content of 1,000 ppm or less.

That is, as shown in Comparative Example 1 below, even if porous ion exchange resin is used, if the water content of the organic solvent to be treated exceeds 1,000 ppm, the impurity removal effect of the present invention cannot be obtained. The water content of the organic solvent may be 1,000 ppm or less, but may be 500 ppm or less. Usually, the lower limit of the water content of the organic solvent is about 50 ppm.

In order to reduce the water content of the organic solvent to 1,000 ppm or less, examples include a method of treating the organic solvent with a dehydrating agent such as anhydrous sodium sulfate, a method of dehydrating with a membrane, and a method of mixing with an organic solvent with a low water content. The aforementioned may be used in combination of two or more.

Therefore, as a method for removing impurities in an organic solvent according to the present invention, before the material for removing impurities of the present invention is brought into contact with an organic solvent, examples include a method of performing a dehydration process of the organic solvent as described above.

### EXAMPLE

Hereinafter, the effects of the present invention will be described in more detail with reference to Examples and Comparative Examples. The following examples are an embodiment of the present invention, and the organic solvent to be treated, the material for removing impurities, the particulates to be removed, etc. are not limited to those used in the following examples.

In the following Examples and Comparative Examples, the following material for removing impurities and test liquid preparation material were used and brought into contact with each other by the following test method.

### <Material for Removing Impurities>

HPA512L: manufactured by Mitsubishi Chemical Corporation
   “Diaion (registered trademark) HPA512L”
   high porous anion exchange resin
   skeleton: poly(styrene-ethylstyrene-divinylbenzene)
   ion exchange group: trimethylammonium group
   specific surface area: 15 m²/g (measured by mercury porosimetry)
KR-FA: manufactured by Kurita Industries Co., Ltd.
   “KR-FA”
   gel type anion exchange resin
   skeleton: poly(styrene-ethylstyrene-divinylbenzene)
   ion exchange group: trimethylammonium group
   specific surface area: 0.2 m²/g (measured by mercury porosimetry)

### <Test Liquid Preparation Material>

organic solvent: isopropyl alcohol (EL grade IPA for electronic industry manufactured by Kanto Kagaku Co., Ltd.)
organic solvent water content: 50,000 to 70,000 ppm. 1,000 ppm or less (measured by Karl Fischer method)
model particulates: silica particulates “sicastar” manufactured by COREFRONT Corp. (particle size 30 nm)
water for water content adjustment: ultrapure water (specific resistance 18.2 M Ω·cm or more)

### <Test Method>

10 g of the material for removing impurities was immersed in 100 mL of isopropyl alcohol containing 50 ppm of silica particulates, the material for removing impurities was shaken and stirred for 30 minutes, and a removal operation was performed. Thereafter, isopropyl alcohol was sampled, and the silica concentration in the isopropyl alcohol was measured by molybdenum blue spectrophotometry. The silica particulate removal rate was calculated from the silica concentration in isopropyl alcohol before and after the removal operation.

### Example 1; Comparative Examples 1 to 3

IPA adjusted to the water content shown in Table 1 was treated with the material for removing impurities shown in Table 1, the silica particulate removal rate was calculated, and the results are shown in Table 1.

TABLE 1

| | Material for | Isopropyl alcohol | |
|---|---|---|---|
| | removing | water content | Silica particulate |
| | impurities | (ppm) | removal rate (%) |
| Example 1 | HPA512L | 639 | 44.2 |
| Comparative | HPA512L | 58,700 | 11.7 |
| Example 1 | | | |
| Comparative | KR-FA | 936 | 17.5 |
| Example 2 | | | |
| Comparative | KR-FA | 67,100 | 17.2 |
| Example 3 | | | |

From Table 1, it can be seen that by using porous ion exchange resin and setting the water content of the organic solvent to 1,000 ppm or less, the capability to remove silica particulates is significantly improved (Example 1).

On the other hand, even if porous ion exchange resin is used, sufficient removal capability cannot be obtained when the water content of the organic solvent exceeds 1,000 ppm (Comparative Example 1).

Furthermore, gel type ion exchange resin cannot provide sufficient removal capability regardless of the water content of the organic solvent (Comparative Examples 2 and 3).

Although the present invention has been described in detail using specific embodiments, it will be apparent to those skilled in the art that various modifications can be made without departing from the spirit and scope of the present invention.

The application is based on Japanese Patent Application Laid-Open No. 2021-195467 filed on Dec. 1, 2021, which is incorporated by reference in its entirety.

1. A material for removing impurities in an organic solvent having a water content of 1,000 ppm or less, the material comprising: porous ion exchange resin.

2. The material for removing impurities in the organic solvent according to claim 1, wherein the porous ion exchange resin comprises one or more functional groups selected from a group consisting of a primary amino group, a secondary amino group, a tertiary amino group, and a quaternary ammonium group as an ion exchange group.

3. The material for removing impurities in the organic solvent according to claim 1, wherein the porous ion exchange resin has a specific surface area of 1 m²/g or more.

4. The material for removing impurities in the organic solvent according to claim 1, wherein the impurities are silica particulates having a particle size of 30 nm or less.

5. A method for removing impurities in an organic solvent, comprising: bringing the material for removing impurities in the organic solvent according to claim 1 into contact with an organic solvent having a water content of 1,000 ppm or less.

6. A method for removing impurities in an organic solvent, comprising a dehydration process of dehydrating an organic solvent with a water content of more than 1,000 ppm to a water content of 1,000 ppm or less; and an impurity removing process of bringing the organic solvent dehydrated into contact with the material for removing impurities in the organic solvent according to claim 1.
